(19) United States
(12) Patent Application Publication
(10) Pub. No.: US 2026/0113760 A1
(43) Pub. Date: Apr. 23, 2026

(54) CHANNEL ACCESS PRIORITY CLASS SELECTION FOR SIDELINK OPERATION WITH SHARED SPECTRUM CHANNEL ACCESS

(71) Applicant: Lenovo (Singapore) Pte. Ltd., Singapore (SG)

(72) Inventors: Joachim Löhr, Wiesbaden (DE); Alexander Golitschek Edler von Elbwart, Darmstadt (DE); Karthikeyan Ganesan, Nauheim (DE); Prateek Basu Mallick, Dreieich (DE)

(21) Appl. No.: 19/114,225

(22) PCT Filed: Oct. 20, 2023
(86) PCT No.: PCT/IB2023/060641

§ 371 Date: Mar. 21, 2025

Related U.S. Application Data
(60) Provisional application No. 63/418,001, filed on Oct. 20, 2022.

(51) Int. Cl. H04W 72/25; H04W 74/0808

(52) U.S. Cl. CPC H04W 72/25; H04W 74/0808

(57) ABSTRACT

Various aspects of the present disclosure relate to sidelink (SL) operation in a cell with shared spectrum channel access. A UE may be configured to generate an SL transport block (TB) to be transmitted to a set of Rx UEs, the TB including data units from multiple SL logical channels (LCHs), each SL LCH associated with a respective channel access priority class (CAPC). The UE may be configured to determine a highest priority CAPC associated with the SL TB and to select a CAPC value for the SL TB based at least in part on the highest priority CAPC satisfying a threshold. The UE may be configured to perform a listen-before-talk (LBT) procedure using parameters corresponding to the selected CAPC value and to transmit the SL TB based at least in part on a success of the LBT procedure.

### TECHNICAL FIELD

The present disclosure relates to wireless communications, and more specifically to Channel Access Priority Class (CAPC) selection for sidelink (SL) operation in a cell with shared spectrum channel access considering the Packet Delay Budget (PDB) requirements.

### BACKGROUND

A wireless communications system may include one or multiple network communication devices, such as base stations, which may be otherwise known as an evolved NodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) Radio Access Technology (RAT), fourth generation (4G) RAT, fifth generation (5G) RAT, among other suitable RATs beyond 5G (e.g., sixth generation (6G)).

Sidelink communication refers to peer-to-peer communication directly between UEs. Accordingly, the UEs communicate with one another without the communications being relayed via the mobile network (i.e., without the need of a base station).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include a UE comprising a means for generating an SL transport block to be transmitted to a set of receiving UEs (Rx UEs) over a sidelink channel, wherein the transport block (TB) comprises data units associated with a plurality of SL logical channels (LCHs), each LCH associated with a respective channel access priority class (CAPC). The UE described herein may further comprise a means for determining a highest priority CAPC associated with the SL TB and a means for selecting a CAPC value for the SL TB based at least in part on the highest priority CAPC satisfying a threshold. The UE described herein may further comprise a means for performing a Listen-Before-Talk (LBT) procedure using a set of LBT parameters corresponding to the selected CAPC value and a means for transmitting the SL TB based at least in part on a success of the LBT procedure.

### BRIEF DESCRIPTION OF THE DRAWINGS

FIG. 1 illustrates an example of a wireless communication system in accordance with aspects of the present disclosure.

FIG. 2 illustrates an example of a Third Generation Partnership Project (3GPP) New Radio (NR) protocol stack showing different protocol layers in the UE and network, in accordance with aspects of the present disclosure.

FIG. 3 illustrates an example of a radio frame during which an LBT procedure is performed, in accordance with aspects of the present disclosure.

FIG. 4 illustrates an example of a SL protocol stack showing different protocol layers in a pair of UEs, in accordance with aspects of the present disclosure.

FIG. 5 illustrates an example of a medium access control (MAC) protocol data unit (PDU) for SL operation in a cell with shared spectrum channel access, in accordance with aspects of the present disclosure.

FIG. 6 illustrates an example of a user equipment (UE) 600, in accordance with aspects of the present disclosure.

FIG. 7 illustrates an example of a processor 700, in accordance with aspects of the present disclosure.

FIG. 8 illustrates an example of a network equipment (NE) 800, in accordance with aspects of the present disclosure.

FIG. 9 illustrates a flowchart of a first method performed by a UE for CAPC selection for SL operation in a cell with shared spectrum channel access, in accordance with aspects of the present disclosure.

FIG. 10 illustrates a flowchart of a second method performed by a UE for CAPC selection for SL operation in a cell with shared spectrum channel access, in accordance with aspects of the present disclosure.

FIG. 11 illustrates a flowchart of a third method performed by a UE for CAPC selection for SL operation in a cell with shared spectrum channel access, in accordance with aspects of the present disclosure.

FIG. 12 illustrates a flowchart of a fourth method performed by a UE for CAPC selection for SL operation in a cell with shared spectrum channel access, in accordance with aspects of the present disclosure.

FIG. 13 illustrates a flowchart of a fifth method performed by a UE for CAPC selection for SL operation in a cell with shared spectrum channel access, in accordance with aspects of the present disclosure.

### DETAILED DESCRIPTION

Generally, the present disclosure describes systems, methods, and apparatuses for CAPC selection for SL operation in a cell with shared spectrum channel access. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

In certain wireless communications networks, such as in NR unlicensed (NR-U) operation, channel access in both downlink (DL) and uplink (UL) relies on an LBT procedure to determine channel availability. In such embodiments, a radio node, e.g., base station unit (e.g., gNB) and/or UE, must first sense the channel to find out there is no on-going communications prior to any transmission. When a communication channel is a wide bandwidth unlicensed carrier, a clear channel assessment (CCA) procedure relies on detecting an energy level on multiple sub-bands of a communications channel. In some embodiments, no beamforming is considered for LBT in NR-U and only omni-directional LBT is used.

In various embodiments, such as for NR-U, LBT failure handling includes: 1) a MAC entity relying on reception of a notification of UL LBT failure from a physical (PHY) layer to detect a consistent UL LBT failure: 2) a UE switching to another bandwidth part (BWP) and initiating a random access channel (RACH) upon declaration of consistent LBT failure on a primary cell (PCell) or a primary serving cell (PSCell) if there is another BWP with configured RACH resources: 3) the UE shall perform radio link failure (RLF) recovery if a consistent UL LBT failure is detected on the PCell and UL LBT failure is detected on “N” possible BWP: 4) if consistent UL LBT failures are detected on the PSCell, the UE informs a mobile network (MN) via a secondary cell group (SCG) failure information procedure after detecting a consistent UL LBT failure on “N” BWPs: 5) “N” is the number of configured BWPs with configured Physical Random Access Channel (PRACH) resources-if N is larger than one it is up to UE implementation to determine which BWP the UE selects; and/or 6) if consistent UL LBT failures are detected on a secondary cell (SCell), a new MAC Control Element (CE) to report this to the node where SCell belongs to is used.

In certain embodiments, a consistent LBT failure UE is allowed to autonomously switch an UL BWP. Other UL BWPs of an NR-U cell may not be subject to large number of LBT failures (e.g., different LBT sub-bands are used for different UL BWPs).

In some embodiments, such as for Long-Term Evolution (LTE) enhanced licensed assisted access (eLAA), autonomous uplink (AUL) transmissions are enabled through a combination of radio resource control (RRC) signaling and an activation message conveyed by Downlink Control Information (DCI) in a physical control channel. The RRC configuration includes subframes in which the UE is allowed to transmit autonomously, as well as eligible hybrid automatic repeat request (HARQ) process identifiers (IDs). The activation message includes the resource block assignment (RBA) and modulation and coding scheme (MCS), from which the UE is able to determine the transport block size for any AUL transmission.

In various embodiments, it is possible to autonomously retransmit data pertaining to a transport block (TB) that has not been received correctly by an eNB. For this purpose, the UE monitors Downlink Feedback Information (DFI) (e.g., AUL-DFI), which can be transmitted by the eNB and includes HARQ acknowledgment (HARQ-ACK) information for the AUL-enabled HARQ process IDs. As used herein, HARQ-ACK may represent collectively the Positive Acknowledge (ACK) and the Negative Acknowledge (NACK). In certain embodiments, the HARG-ACK also represents the Discontinuous Transmission (DTX). ACK means that a TB is correctly received while NACK means a TB is erroneously received. DTX indicates that no transmission was detected by the receiving device.

If the UE detects a NACK message, it may try to autonomously access the channel for a retransmission of the same transport block in the corresponding HARQ process. As a safe-guard against errors, an AUL transmission includes at least the HARQ process ID and a new data indicator (NDI) accompanying a physical uplink shared channel (PUSCH) (e.g., AUL uplink control information (AUL-UCI)).

In certain embodiments, it is possible for the eNB to transmit an UL grant through a DCI that assigns UL resources for a retransmission of the same transport block using an indicated HARQ process. It is further possible that the eNB transmits an UL grant through a DCI that assigns UL resources for transmission of a new transport block using the indicated HARQ process. In other words, even though a HARQ process ID can be eligible for AUL transmissions, the eNB still has access to this process at any time through a scheduling grant (e.g., DCI). In general, if the UE detects a grant for an UL transmission for a subframe that is eligible for AUL (e.g., according to an RRC configuration), it will follow the received grant and will not perform an AUL transmission in that subframe. Table 1 illustrates one embodiment of fields for AUL-UCI.

TABLE 1
Fields for AUL-UCI

Bit width

| | 1 transport | 2 transport |
|---|---|---|
| Field | block | blocks |
| AUL cell radio network temporary | 16 | 16 |
| identifier (C-RNTI) | | |
| HARQ process number | 4 | 4 |
| Redundancy version | 2 | 2 |
| New data indicator | 1 | 2 |
| PUSCH starting symbol | 1 | 1 |
| PUSCH ending symbol | 1 | 1 |
| Channel occupancy time (COT) | 1 | 1 |
| sharing indication | | |

In some embodiments, COT sharing is shown by: 1) sharing of a UE-initiated channel occupancy (e.g., either configured grant (CG) PUSCH (i.e., “CG-PUSCH”) or scheduled UL) with gNB supported, such that the gNB is allowed to transmit control signals, broadcast signals, control channels, and/or broadcast channels for any UEs as long as the transmission contains transmissions for the UE that initiated the channel occupancy (CO) and/or DL signals and/or channels (e.g., Physical Downlink Shared Channel (PDSCH), Physical Downlink Control Channel (PDCCH), reference signals) meant for the UE that initiated the channel occupancy: 2) a threshold (e.g., energy detection (ED) threshold) that the UE applies if initiating a channel occupancy to be shared with the gNB if configured by the gNB (e.g., RRC signaling), a) if the threshold that the UE applies if initiating a channel occupancy to be shared with the gNB is not configured, the transmission of the gNB in UE initiated COT may include only control and/or broadcast signals and/or channels transmissions of up to 2, 4, and/or 8 orthogonal frequency division multiplexing (OFDM) symbols in duration for 15, 30, and/or 60 kHz subcarrier spacing (SCS), and b) if absence of wireless local area network (WLAN) (e.g., wireless fidelity or “Wi-Fi”) cannot be assumed based on a regulation, the threshold that the gNB configures to the UE to apply if initiating the channel occupancy is determined based on a maximum gNB transmit (TX) power: 3) category 2 LBT is used (e.g., for gaps of 16 us and 25 us): 4) category 1 LBT is used under the following conditions: a) gap duration <=16 us, b) for the transmission of the gNB after the first switch between the UE and the gNB if the gNB transmission contains only control and/or broadcast signals and/or channels, and c) for the transmission of the gNB after the first switch between the UE and the gNB if the gNB transmission has a duration below X ms (e.g., X>=0).

In various embodiments, for a category 2 LBT in a 16 us gap, energy measurement is done for a total of at least 5 us with at least 4 us of sensing falling within the 9 us slot immediately before the transmission. LBT is said to be successful if the measured energy is lower than a threshold.

In certain embodiments, NR-U LBT procedures for channel access may be summarized as follows: 1) both gNB-initiated and UE-initiated COTs use category 4 (Cat4) LBT where the start of a new transmission burst always performs LBT with exponential backoff-only with the exception that if the demodulation reference signal (DRS) is to be at most one ms in duration and is not multiplexed with unicast PDSCH; and/or 2) UL transmission within a gNB initiated COT or a subsequent DL transmission within a UE or gNB initiated COT transmits immediately without sensing only if the gap from the end of the previous transmission is not more than 16 us, otherwise category 2 LBT must be used and the gap cannot exceed 25 μs.

In some embodiments, the UE and/or gNB in unlicensed carriers has to perform an LBT operation, and within category 4 LBT, several CAPCs are defined to have differentiated channel access parameters as shown in Table 2 (for the DL case) and Table 3 (for the UL case).

TABLE 2
CAPC for DL

| CAPC (p) | mₚ | CWₘᵢₙₚ | CWₘₐₓₚ | T_{mcotp} | allowed CWₚ sizes |
|---|---|---|---|---|---|
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, 127, 255, 511, 1023} |

TABLE 3
CAPC for UL

| CAPC (p) | mₚ | CWₘᵢₙₚ | CWₘₐₓₚ | T_{ulm cot, p} | allowed CWₚ sizes |
|---|---|---|---|---|---|
| 1 | 2 | 3 | 7 | 2 ms | {3, 7} |
| 2 | 2 | 7 | 15 | 4 ms | {7, 15} |
| 3 | 3 | 15 | 1023 | 6 or 10 ms | {15, 31, 63, 127, 255, 511, 1023} |
| 4 | 7 | 15 | 1023 | 6 or 10 ms | {15, 31, 63, 127, 255, 511, 1023} |

Note that for Table 3, for p=3,4, T_{ulm cot,p}=10 ms if the higher layer parameters absenceOfAnyOtherTechnology-r14 or absenceOfAnyOtherTechnology-r16 is provided, otherwise, T_{ulm cot, p}=6 ms. When T_{ulm cot, p}=6 ms it may be increased to 8 ms by inserting one or more gaps. The minimum duration of a gap shall be 100 μs. The maximum duration before including any such gap shall be 6 ms.

According to the current 3GPP specifications, the UE selects the lowest priority CAPC of the LCHs with MAC service data unit (SDU) multiplexed in the TB for cases when the TB does not contain a MAC CE or Signaling Radio Bearer (SRB). Applying the same behavior for Sidelink transmissions, e.g., when Tx UE selects the CAPC value, would potentially lead a UE to select a high CAPC index (e.g., due to the TB containing lower priority data), even though sidelink resources are selected according to the PDB of the TB which is determined based on the LCH with the most stringed PDB requirements. Hence, there may be a mismatch between the CAPC value selected for a TB and the PDB of the TB.

In a prior art solution, the Tx UE would select the lowest priority CAPC value of the LCHs with MAC SDU multiplexed in the TB. Hence, there may be a mismatch between the CAPC value determined for a TB and the PDB of the TB. For example, the LBT procedure (e.g., as described in 3GPP Technical Specification (TS) 37.213, clauses 4.1.1, 4.1.2, 4.2.1.1, 4.2.2.2) including the contention window determined as a function of the CAPC may not reach the condition for allowing a transmission before the PDB of a TB expires, e.g., the minimum total required channel access sensing duration may be too large. Therefore, the prior art solutions may lead to the selection of incorrect channel access parameter for the SL TB.

In a first set of solutions, a UE selects the highest priority CAPC of the SL logical channel(s), e.g., Sidelink Traffic Channel (STCH), with MAC SDU multiplexed in a TB, for cases when the highest priority CAPC of the SL LCH(s) is above a preconfigured CAPC threshold. Otherwise, i.e., for cases that highest priority CAPC value of the SL logical channel(s) is below the preconfigured CAPC threshold, the UE selects the lowest priority CAPC of the SL logical channels with MAC SDU multiplexed in the TB.

In another set of solutions, a UE uses the highest CAPC priority for a SL TB, if there is data contained in the TB which has the highest priority CAPC, i.e., highest priority CAPC=1. According to one implementation of the embodiment, such data could be: a SL MAC CE, or a Sidelink Control Channel (SCCH) MAC SDU, or Sidelink Broadcast Control Channel (SBCCH) MAC SDU, or STCH MAC SDU. According to this embodiment, it is ensured that for cases that a SL TB is comprised of data with the highest priority CAPC, the UE uses the highest priority CAPC for the transmission of the SL TB regardless of what other data is multiplexed in the SL TB.

Aspects of the present disclosure are described in the context of a wireless communications system.

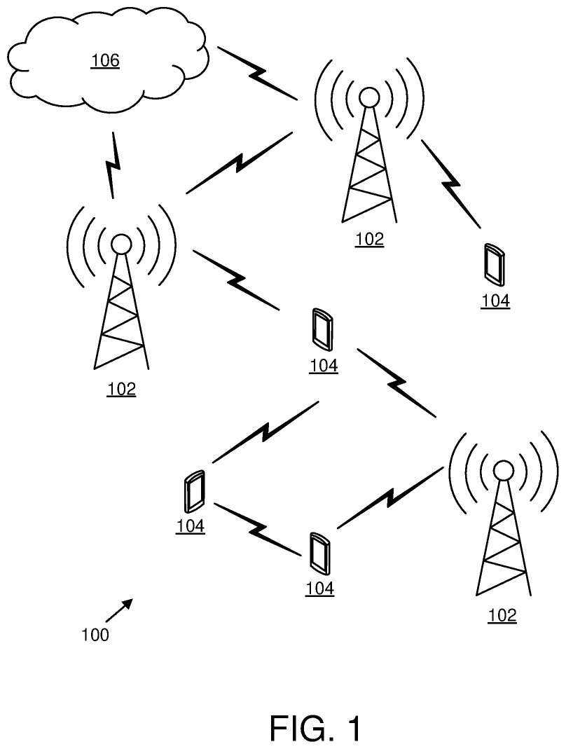

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing: a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Wireless communication in unlicensed spectrum (also referred to as “shared spectrum”) in contrast to licensed spectrum offer some obvious cost advantages allowing communication to obviate overlaying operator's licensed spectrum and rather use license free spectrum according to local regulation in specific geographies. From the Third Generation Partnership Project (3GPP) technology perspective, the unlicensed operation can be on the Uu interface (referred to as NR-U) or also on sidelink interface (e.g., SL-U).

For initial access, a UE 104 detects a candidate cell and performs DL synchronization. For example, the gNB (e.g., an embodiment of the NE 102) may transmit a synchronization signal and broadcast channel (SS/PBCH) transmission, referred to as a Synchronization Signal Block (SSB). The synchronization signal is a predefined data sequence known to the UE 104 (or derivable using information already stored at the UE 104) and is in a predefined location in time relative to frame/subframe boundaries, etc. The UE 104 searches for the SSB and uses the SSB to obtain DL timing information (e.g., symbol timing) for the DL synchronization. The UE 104 may also decode system information (SI) based on the SSB. Note that with beam-based communication, each DL beam may be associated with a respective SSB.

After performing DL synchronization and acquiring essential system information, such as the Master Information Block (MIB) and the System Information Block type 1 (SIB1), the UE 104 performs uplink (UL) synchronization and resource request by performing a random access procedure, referred to as “RACH procedure” by selecting and transmitting a preamble on the Physical Random Access Channel (PRACH). The PRACH preamble is transmitted during a RACH occasion, i.e., a predetermined set of time-frequency resources that are available for the reception of the PRACH preamble. Note that with beam-based communication, the UE 104 may select a certain DL beam and transmit the PRACH preamble on a corresponding UL beam. In such embodiments, there may be a mapping between SSB and RACH occasion, allowing the network to determine which beam the UE 104 has selected.

To complete the RACH procedure, after transmitting the PRACH preamble (also referred to as “Msg1”), the UE 104 monitors for a random-access response (RAR) message (also referred to as “Msg2”). The gNB transmits UL timing adjustment information in the RAR and may also schedule an UL resource, referred to as an initial uplink grant.

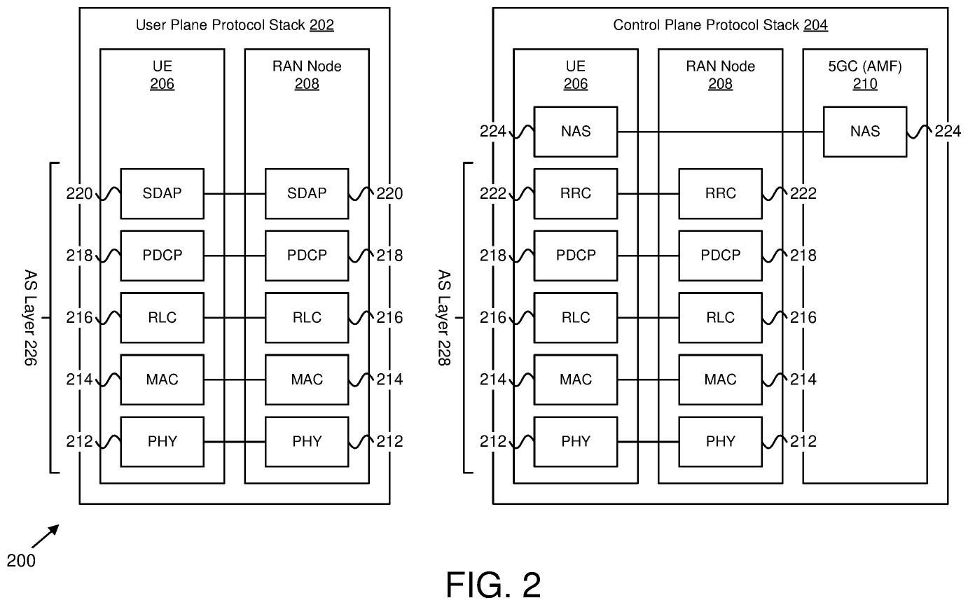

FIG. 2 illustrates an example of a NR protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the NR protocol stack 200 comprises a User Plane protocol stack 202 and a Control Plane protocol stack 204. The User Plane protocol stack 202 includes a PHY layer 212, a MAC sublayer 214, a Radio Link Control (RLC) sublayer 216, a Packet Data Convergence Protocol (PDCP) sublayer 218, and a Service Data Adaptation Protocol (SDAP) layer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-1 (L1) includes the PHY layer 212. The Layer-2 (L2) is split into the SDAP sublayer 220, PDCP sublayer 218, RLC sublayer 216, and MAC sublayer 214. The Layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of SRBs and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as Transport Blocks (TBs)) from MAC Service Data Units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as UL or DL. Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

Note that an LTE protocol stack comprises similar structure to the NR protocol stack 200, with the differences that the LTE protocol stack lacks the SDAP sublayer 220 in the AS layer 226, that an EPC replaces the 5GC 510, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in Multiple-Input Multiple-Output (MIMO) communication (also referred to as a “MIMO layer” or a “data stream”).

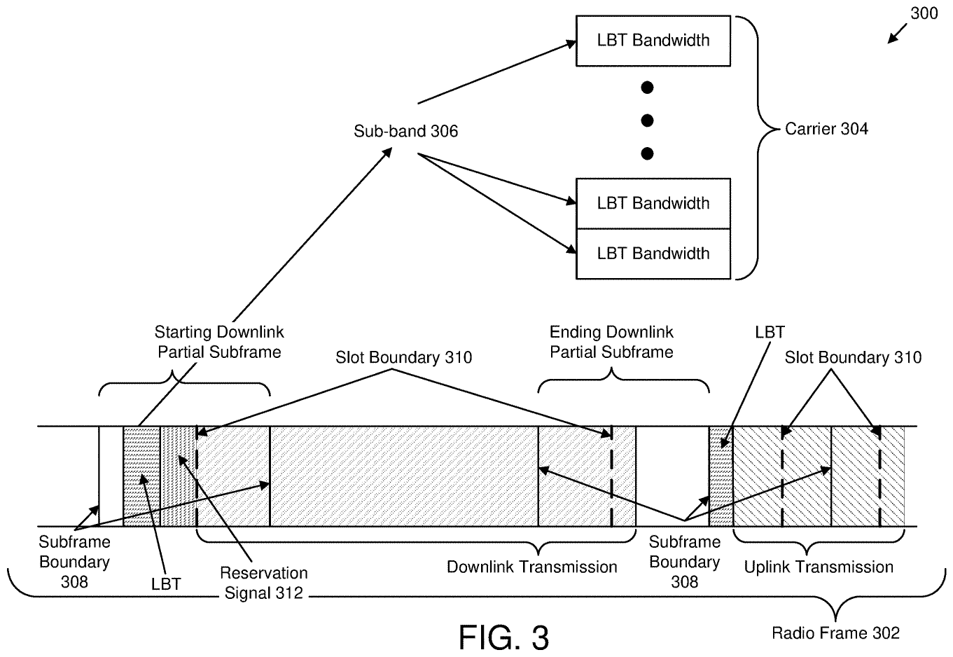

FIG. 3 depicts an LBT procedure 300 for a radio frame 302 for communication on unlicensed spectrum, according to embodiments of the disclosure. When a communication channel is a wide bandwidth unlicensed carrier 304 (e.g., several hundred MHz), the CCA/LBT procedure relies on detecting the energy level on multiple sub-bands 306 of the communications channel as shown in FIG. 3. The LBT parameters (such as type/duration, clear channel assessment parameters, etc.) may be configured in the UE 206 by the RAN node 208. In one embodiment, the LBT procedure is performed at the PHY layer 212.

FIG. 3 also depicts frame structure of the radio frame 302 for communication between the UE 206 and RAN node 208 on unlicensed spectrum. The radio frame 302 may be divided into subframes (indicated by subframe boundaries 308) and may be further divided into slots (indicated by slot boundaries 310). The radio frame 302 uses a flexible arrangements where UL and DL operations are on the same frequency channel but are separated in time. However, the subframes are not configured as a DL subframe or an UL subframe and a particular subframe may be used by either the UE 206 or RAN node 208. As discussed previously, LBT is performed prior to a transmission. Where LBT does not coincide with a slot boundary 310, a reservation signal 312 may be transmitted to reserve (i.e., occupy) the channel until the slot boundary is reached and data transmission begins.

With respect to LBT failure handling, the MAC sublayer 214 relies on reception of a notification of LBT failure from the PHY layer 212 to detect/declare consistent UL LBT failure. The UE 206 switches to another BWP and initiates a random-access procedure (i.e., RACH procedure) upon declaration of consistent UL LBT failure on a PCell or a PSCell, if there is another BWP with configured Random Access Channel (RACH) resources.

The UE 206 performs RLF recovery if the consistent UL LBT failure was detected on the PCell and UL LBT failure was detected on ‘N’ possible BWP. When consistent UL LBT failures are detected on the PSCell, the UE 206 informs the RAN, via the SCG failure information procedure, after detecting a consistent UL LBT failure on ‘N’ BWPs, where ‘N’ is the number of configured BWPs with configured PRACH resources. If ‘N’ is larger than one, it is up to the UE implementation which BWP the UE selects.

When consistent UL LBT failures are detected on a SCell, the UE 206 transmits a new MAC CE to report the consistent UL LBT failure to the node to which the SCell belongs. In certain embodiments, the MAC CE can be used to report failure on the PCell.

In other words, in the case of consistent LBT failure, the UE 206 is allowed to autonomously switch the UL BWP. The motivation is that other UL BWP(s) of the NR-U cell may not be subject to large number of LBT failures, i.e., different LBT sub-bands 306 are used for different UL BWP(s).

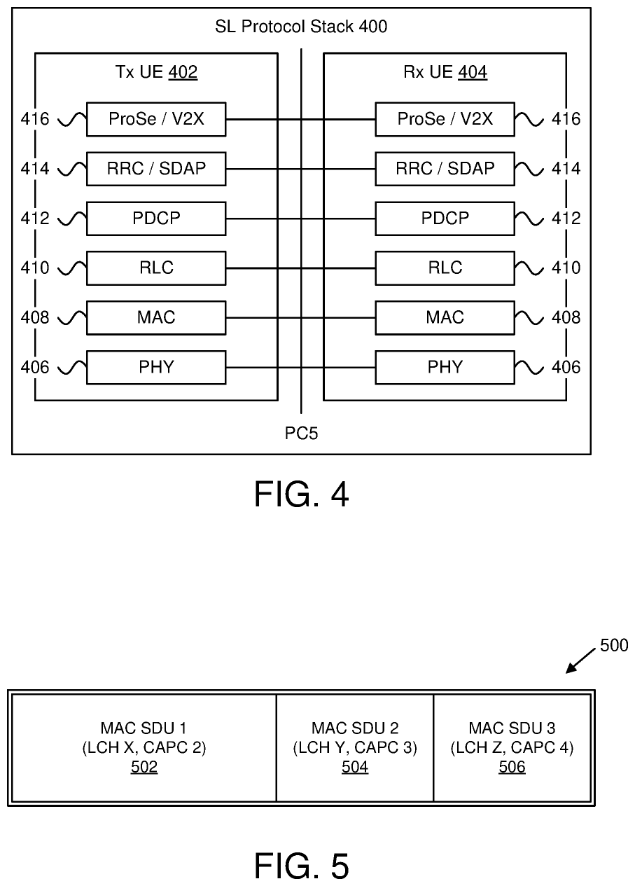

FIG. 4 illustrates a SL protocol stack 400, in accordance with aspects of the present disclosure. While FIG. 4 shows a transmitting SL UE (denoted “Tx UE”) 402 and a receiving SL UE (denoted “Rx UE”) 404, these are representative of a set of UEs using SL communication over a PC5 interface; other embodiments may involve different SL UEs. In various embodiments, each of the Tx UE 402 and the Rx UE 404 may be an embodiment of the UE 104 and/or the UE 206.

As depicted, the SL protocol stack 400 (i.e., PC5 protocol stack) includes a PHY layer 406, a MAC sublayer 408, a RLC sublayer 410, a PDCP sublayer 412, a SDAP sublayer (e.g., for the user plane), and an RRC sublayer (e.g., for the control plane). In FIG. 4, the SDAP sublayer and RRC sublayer are depicted as combined entity “RRC/SDAP layers” 414. There may be additional layers above the RRC/SDAP layers 414, such as a Proximity Services (ProSe) and/or V2X application layer 416.

The AS layer (also referred to as “AS protocol stack”) for the control plane in the PC5 interface consists of at least the RRC sublayer, the PDCP sublayer 412, the RLC sublayer 410, the MAC sublayer 408, and the PHY layer 406. The AS layer (also referred to as “AS protocol stack”) for the user plane in the PC5 interface consists of at least the SDAP sublayer, the PDCP sublayer 412, the RLC sublayer 410, the MAC sublayer 408, and the PHY layer 406.

Similar to the NR protocol stack 200, the L1 refers to the PHY layer 406. The L2 is split into the SDAP sublayer, the PDCP sublayer 412, the RLC sublayer 410, and the MAC sublayer 408. The L3 includes the RRC sublayer for the control plane and includes, e.g., an IP layer or PDU Layer (not depicted) for the user plane. L1 and L2 are generally referred to as “lower layers,” while L3 and above (e.g., transport layer, V2X layer, application layer) are referred to as “higher layers” or “upper layers.” The PHY layer 406, the MAC sublayer 408, the RLC sublayer 410, and the PDCP sublayer 412 perform similar functions as the PHY layer 212, the MAC sublayer 214, the RLC sublayer 216, and the PDCP sublayer 218, described above with reference to FIG. 2.

In various embodiments, the SL communication relates to one or more services requiring SL connectivity, such as V2X services and ProSe services. The Tx UE 402 may establish one or more SL connections with nearby Rx UE 404. For example, a V2X application running on the Tx UE 402 may generate data relating to a V2X service and use a SL connection to transmit the V2X data to one or more nearby Rx UE 404.

In NR-U, channel access in both DL and UL relies on the LBT procedure. The gNB and/or UE must first sense the channel to find out there are no ongoing communications prior to any transmission. When a communication channel is a wide bandwidth unlicensed carrier, the LBT/CCA procedure relies on detecting the energy level on multiple sub-bands of the communications channel as shown in FIG. 3. Note that no beamforming is considered for LBT in NR-U in Release 16 (Rel-16) and only omni-directional LBT is assumed.

In LBT, transmitters are expected to “sense” the medium, based on a Clear Channel Assessment (CCA) protocol, and detect transmissions from other nodes prior to transmitting. The simplest CCA method is energy detection, e.g., to measure the received energy level of signals transmitted from other devices and determine whether a channel is idle or busy.

Regarding SL operation in unlicensed spectrum, in Rel-16, sidelink communication was developed in RAN mainly to support advanced V2X applications. In Release 17 (Rel-17), Proximity-based service including public safety and commercial related service were standardized. As part of Rel-17, power saving solution (e.g., partial sensing, discontinuous reception (DRX)) and inter-UE coordination were developed to improve power consumption for battery limited terminals and reliability of sidelink transmissions.

Although NR sidelink was initially developed for V2X applications, there is growing interest in the industry to expand the applicability of NR sidelink to commercial use cases. For commercial sidelink applications, two key requirements have been identified: 1) increased sidelink data rate, and 2) support of new carrier frequencies for sidelink.

Increased sidelink data rate is motivated by applications such as sensor information (video) sharing between vehicles with high degree of driving automation. Commercial use cases could require data rates in excess of what is possible in Rel-17. Increased data rate can be achieved with the support of sidelink carrier aggregation and sidelink over unlicensed spectrum. Furthermore, by enhancing the FR2 sidelink operation, increased data rate can be more efficiently supported on FR2. While the support of new carrier frequencies and larger bandwidths would also allow improvement to data rate, the main benefit would come from making sidelink more applicable for a wider range of applications. More specifically, with the support of unlicensed spectrum and the enhancement in FR2, sidelink will be in a better position to be implemented in commercial devices since utilization of the ITS band is limited to ITS safety related applications.

Various systems may support sidelink communication on unlicensed spectrum for both mode 1 and mode 2 where Uu operation for mode 1 is limited to licensed spectrum only. In certain embodiments, the channel access mechanisms from NR-U (discussed above with reference to FIG. 3) are reused for SL-U operation and the existing NR sidelink and NR-U channel structure are also reused, as the baseline, for SL-U operation. In other words, the SL devices perform LBT/CCA prior to occupying a channel on unlicensed spectrum.

In NR-U when the UE 206 detects consistent UL LBT failures, it takes actions as specified in 3GPP TS 38.321 and described above. The detection is per Bandwidth Part (BWP) and based on all UL transmissions within this BWP. For cases when sidelink is operated on a cell configured with, the corresponding UE actions upon detection of consistent LBT failures for sidelink transmissions on a resource block (RB) set and/or resource pool (RP) need to be defined.

For SL unlicensed, once a consistent LBT failure has been declared, among others it results into a situation where a SL receiver device (i.e., the Rx UE 404) may not be able to transmit HARQ feedback about a successful or failed reception to a corresponding SL transmitter device (i.e., the Tx UE 402). In absence of multiple of such HARQ feedback(s), i.e., when s/-MaxNumConsecutiveDTX is reached, the Tx UE 402 may deduce that the link between it and the Rx UE 404 has met RLF for the NR sidelink communication transmission and the corresponding PC5-RRC connection is released.

FIG. 5 is a schematic block diagram illustrating one embodiment of a MAC protocol data unit (PDU) 500, in accordance with aspects of the present disclosure. The MAC PDU 500 includes a first MAC SDU (denoted “MAC SDU 1”) 502, a second MAC SDU (denoted “MAC SDU 2”) 504, and a third MAC SDU (denoted “MAC SDU 3”) 506. Here, the first MAC SDU 502 is formed from data associated with a first logical channel (denoted “LCH X”), and a certain CAPC value (here, “CAPC 2”), the second MAC SDU 504 is formed from data associated with a second logical channel (denoted “LCH Y”), and a certain CAPC value (here, “CAPC 3”), and the third MAC SDU 506 is formed from data associated with a third logical channel (denoted “LCH Z”), and a certain CAPC value (here, “CAPC 4”). In various embodiments, the MAC PDU 500 forms a TB to be transmitted via SL communication.

In various embodiments, for dynamically scheduled UL resources (e.g., UL DCI), a gNB indicates a CAPC to be used by a UE for a corresponding UL transmission. For an UL configured grant, a network cannot signal the CAPC index for every occasion, and thus the UE itself has to select which CAPC is used for each occasion. In certain embodiments, for data radio bearers (DRBs), a UE selects a highest CAPC index/value (e.g., corresponding to the lowest priority level) of logical channels (LCHs) multiplexed in a TB. According to this schema, in the FIG. 5, the UE will select the CAPC 4 from Table 2 (e.g., the lowest priority).

In certain embodiments, a very small amount of data belongs to a highest CAPC index, but a UE still has to apply the highest CAPC index for high-priority data, which leads to some delay for the transmission. Therefore, for UL CG, if SRB (e.g., downlink control channel (DCCH)) SDU is included in MAC PDU, a UE selects the CAPC index of the SRB (e.g., DCCH). Otherwise, the UE selects the highest CAPC index (e.g., lowest priority) of LCHs multiplexed in MAC PDU. As used herein a “configured grant” (i.e., CG) refers to a semi-static allocation of resources, i.e., a semi-persistently scheduled grant. Accordingly, the gNB can use a CG to schedule PUSCH resources without using DCI for every transmission.

In some embodiments, a CAPC of radio bearers and MAC CEs are either fixed or configurable as being: 1) fixed to a lowest priority for a padding buffer status report (BSR) and recommended bit rate MAC CEs: 2) fixed to a highest priority for SRB0, SRB1, SRB3, and other MAC CEs; and/or 3) configured by the gNB for SRB2 and DRB.

In various embodiments, if choosing a CAPC of a DRB, a gNB takes into account fifth generation (5G) quality of service (QoS) IDs (5QIs) of all the QoS flows multiplexed in that DRB while considering fairness between different traffic types and transmissions. Table 4 shows which CAPC should be used for which standardized 5QIs (e.g., which CAPC to use for a given QoS flow). It should be noted that a QoS flow corresponding to a non-standardized 5QI (e.g., operator specific 5QI) should use the CAPC of the standardized 5QI which best matches the QoS characteristics of the non-standardized 5QI. In Table 4, it should be noted that a lower CAPC value may mean a higher priority.

TABLE 4
Mapping between CAPC and 5QI

| CAPC | 5QI |
|---|---|
| 1 | 1, 3, 5, 65, 66, 67, 69, 70, 79, 80, 82, 83, 84, 85 |
| 2 | 2, 7, 71 |
| 3 | 4, 6, 8, 9, 72, 73, 74, 76 |
| 4 | — |

In certain embodiments, if performing Cat4 LBT (e.g., Type 1 LBT) for the transmission of an UL TB and if the CAPC is not indicated in DCI, the UE selects the CAPC as follows: 1) if only MAC CEs are included in the TB, the highest priority CAPC of those MAC CEs is used: 2) if common control channel (CCCH) SDUs are included in the TB, the highest priority CAPC is used: 3) if dedicated control channel (DCCH) SDUs are included in the TB, the highest priority CAPC of the DCCHs is used; and/or 4) the lowest priority CAPC of the logical channels with MAC SDU multiplexed in the TB is used otherwise.

According to the behavior specified for NR-U for UL transmission where the CAPC is not indicated in the DCI, e.g., CG PUSCH transmissions, UE selects the lowest priority CAPC of the LCHs with MAC SDU multiplexed in the TB for cases when the TB does not contain a MAC CE or SRB.

Applying the same behavior for Sidelink transmissions over shared spectrum, e.g. allowing the Tx UE to determine the CAPC value following the existing rules (as above), would potentially lead to some situation where UE has to select a high CAPC index for the transmission of a TB, i.e. since low priority data is contained in the TB, but the Sidelink resources are selected, e.g. for mode 2 resource selection, according to the PDB of the TB which is determined based on the LCH with the most stringent PDB requirements (high priority data which is also multiplexed in the TB). Hence, there may be a mismatch between the CAPC value determined for a TB and the PDB of the TB. For example, the LBT procedure—including the contention window determined as a function of the CAPC—may not reach the condition for allowing a transmission before the PDB of a TB expires, e.g., the minimum total required channel access sensing duration may be too large.

Described below are solutions to allow for efficient CAPC handling for sidelink transmission thereby considering the PDB requirements of the LCHs multiplexed in a TB on a cell configured with a shared spectrum and the fairness to other users, e.g., Wi-Fi user. The UE selects the highest priority CAPC of the SL logical channel(s), e.g., STCH, with MAC SDU multiplexed in the TB if the highest priority CAPC is above a preconfigured threshold in order to ensure that the PDB of the TB can be satisfied.

While presented as distinct solutions, one or more of the solutions described herein may be implemented in combination with each other for efficient CAPC handling for sidelink transmission.

According to embodiments of the first solution, the UE selects the highest priority CAPC of the SL logical channel(s), e.g., STCH, with MAC SDU multiplexed in a TB, for cases when the highest priority CAPC of the SL LCH(s) is above a preconfigured CAPC threshold. It should be noted that a lower CAPC value corresponds to a higher CAPC priority, i.e., CAPC=1 corresponds to the highest CAPC priority.

According to one implementation of the first solution, the UE selects the highest priority CAPC of the SL logical channel(s), i.e., STCH, with MAC SDU multiplexed in a TB when the highest priority CAPC of the SL LCH(s) is above a preconfigured CAPC threshold for cases when the SL TB does not contain SL MAC CE(s) and/or SCCH SDUs and/or SBCCH SDU(s). Otherwise, i.e., for cases that highest priority CAPC value of the SL logical channel(s) is below the preconfigured CAPC threshold, UE selects the lowest priority CAPC of the SL logical channels with MAC SDU multiplexed in the TB.

According to one implementation of the first solution, the UE selects the CAPC when (or prior to) performing LBT for the transmission of a sidelink TB for cases that the CAPC is not indicated within a control information such as DCI or Sidelink Control Information (SCI), e.g., for mode 2 resource allocation, according to some predefined rules. Such rules may be e.g. one of the following or a combination thereof, where the combination may be a logical OR combination:

The highest priority SL CAPC is used: A) If only SL MAC CE(s) are included in the SL TB: B) If SCCH SDU(s) are included in the SL TB, the highest priority SL CAPC is used: or C) If SBCCH SDU(s) are included in the SL TB, the highest priority SL CAPC is used.

In this implementation, the highest priority SL CAPC of the SL logical channel(s), e.g., STCH, with MAC SDU multiplexed in the SL TB is used otherwise for cases when the highest priority SL CAPC is above a predefined CAPC threshold. The lowest priority SL CAPC of the SL logical channel(s), e.g., STCH, with MAC SDU multiplexed in the SL TB is used otherwise for cases when the highest priority SL CAPC is equal to or below the predefined CAPC threshold.

According to another implementation of the first solution, the UE selects the CAPC when (or prior to) performing LBT for the transmission of a sidelink TB for cases that the CAPC is not indicated within a control information such as DCI or SCI according to some predefined rules. Such rules may be e.g. one of the following or a combination thereof, where the combination may be a logical OR combination:

The highest priority SL CAPC is used: A) If only SL MAC CE(s) are included in the SL TB: B) If SCCH SDU(s) are included in the SL TB, the highest priority SL CAPC is used: or C) If SBCCH SDU(s) are included in the SL TB, the highest priority SL CAPC is used.

In this implementation, the highest priority SL CAPC of the SL logical channel(s), e.g., STCH, with MAC SDU multiplexed in the SL TB is used otherwise for cases when the highest priority SL CAPC is equal to or above a predefined CAPC threshold. The lowest priority SL CAPC of the SL logical channel(s), e.g., STCH, with MAC SDU multiplexed in the SL TB is used otherwise for cases when the highest priority SL CAPC is below the predefined CAPC threshold.

It should be noted that the SBCCH is a channel for broadcasting SL system information from one UE to other UE(s). The Sidelink Control Channel (SCCH) is a channel for transmission of control information (i.e., PC5-RRC and PC5-S messages) from one UE to other UE(s). As used herein, the Sidelink Traffic Channel (STCH) refers to a logical channel for transmission of user data from one UE to other UE(s).

Note that the Tx UE 402 and/or Rx UE 404 may be provided with different SL communication resources according to different allocation modes. Allocation Mode-1 corresponds to a NR-based network-scheduled SL communication mode, wherein the in-coverage gNB indicates resources for use in SL operation, including resources of one or more resource pools. Allocation Mode-2 corresponds to a NR-based UE-scheduled SL communication mode (i.e., UE-autonomous selection), where the Tx UE 402 and/or Rx UE 404 selects a resource pools and resources therein from a set of candidate pools. Allocation Mode-3 corresponds to an LTE-based network-scheduled SL communication mode. Allocation Mode-4 corresponds to an LTE-based UE-scheduled SL communication mode (i.e., UE-autonomous selection).

As used herein, a “resource pool” refers to a set of resources assigned for sidelink operation. A resource pool consists of a set of resource blocks (i.e., Physical Resource Blocks (PRBs)) over one or more time units (e.g., Orthogonal Frequency Division Multiplexing (OFDM) symbols, subframes, slots, subslots, etc.). In some embodiments, the set of resource blocks comprises contiguous PRBs in the frequency domain. A PRB, as used herein, consists of twelve consecutive subcarriers in the frequency domain. In certain embodiments, a UE may be configured with separate transmission resource pools (Tx RPs) and reception resource pools (Rx RPs), where the Tx RP of one UE is associated with an Rx RP of another UE to enable SL communication.

According to embodiments of the second solution, the UE uses as a CAPC priority for a TB the highest priority SL CAPC of the SL logical channel(s) with MAC SDU multiplexed in the TB for cases when the TB contains at least a predefined amount/ratio of data of the SL logical channel with the highest priority CAPC.

According to one implementation of the second solution, if the TB does not contain any SL MAC CE(s) or SCCH SDU(s) or SBCCH SDU(s), then the UE selects the highest priority SL CAPC of the SL logical channel(s) with MAC SDU multiplexed in the TB as the CAPC for the TB for cases when the TB contains at least a predefined amount/ratio of data of the SL logical channel with the highest priority CAPC. If more than ‘x’ percent of a SL TB is filled with data of the SL logical channel with the highest priority CAPC, then the UE selects the CAPC for the SL TB as the highest priority SL CAPC of the SL logical channel(s) with MAC SDU.

The predefined amount/ratio of data (i.e., corresponding to the ‘x’ percent) may be part of the resource pool configuration parameters. In certain embodiments, the predefined amount of data may be expressed as an absolute number of bits, bytes, octets, and so forth. In certain embodiments, predefined ratio of data may be expressed as a relative value, e.g., a percentage, with respect of the total size of the TB in question at a particular instant.

For example, for a transmission the total size of the TB is 1500 bytes, and the predefined ratio of data is 75%. Then according to the second solution, for that TB/transmission, if the TB contains at least 75% (i.e., 1125 bytes) of data of the SL logical channel with the highest priority CAPC, then the UE selects the highest priority CAPC of the SL logical channel(s) with MAC SDU multiplexed in the TB; otherwise, the UE selects the lowest priority CAPC of the SL logical channel(s) with MAC SDU multiplexed in the TB.

Referring to FIG. 5, assume that the first MAC SDU 502 occupies 65% of the TB, the second MAC SDU 504 occupies 20% of the TB, and the third MAC SDU 506 occupies 15% of the TB. For the above example where the predefined ratio of data is 75%, the Tx UE 402 would handle the TB as follows. The highest priority SL CAPC (i.e., lowest CAPC index/value) of the SL logical channel(s) with MAC SDU multiplexed in the TB corresponds to CAPC 2 and the first MAC SDU 502. However, because the first MAC SDU 502 occupies less than the predefined ratio/percentage, the Tx UE 402 does not select CAPC for the TB and instead selects the lowest priority SL CAPC (i.e., CAPC 4, associated with the third MAC SDU 506).

According to embodiments of the third solution, the UE determines the amount/ratio of data corresponding to a priority equal to or higher than a SL CAPC priority. The UE uses as the highest CAPC priority for a TB the SL CAPC priority for which the amount/ratio of data corresponding to the priority being equal to or higher than the SL CAPC priority exceeds a predefined amount/ratio.

For example, assume that a first CAPC priority is higher than a second CAPC priority and the second CAPC priority is higher than a third CAPC priority. Further assume that data corresponding to the first SL CAPC priority occupies 20% of the TB, and data corresponding to the second SL CAPC priority occupies 65% of the TB, and data corresponding to the third SL CAPC priority occupies 15% of the TB. Accordingly, the data corresponding to the first CAPC priority (i.e., highest priority, as in this example there is no higher priority data) occupies 20% of the TB, the data corresponding to the second CAPC priority (i.e., next highest priority) occupies 20%+65%=85% of the TB, and the data corresponding to the third CAPC priority (i.e., next higher priority) occupies 20%+65%+15%=100% of the TB.

In keeping with the above example, if the predefined ratio is 75%, then the UE uses the second CAPC priority for the TB since the corresponding 85% exceeds the ratio. However, if the predefined amount is 90%, then the UE uses the third CAPC priority in this example (i.e., because the 85% corresponding to the second CAPC priority does not exceed the predefined ratio).

Applying the third solution to FIG. 5, assume that the first MAC SDU 502 occupies 65% of the TB, the second MAC SDU 504 occupies 20% of the TB, and the third MAC SDU 506 occupies 15% of the TB. For the above example where the predefined ratio of data is 75%, the Tx UE 402 would handle the TB as follows. The highest priority SL CAPC (i.e., lowest CAPC index/value) of the SL logical channel(s) with MAC SDU multiplexed in the TB corresponds to CAPC 2 and the first MAC SDU 502. However, because the first MAC SDU 502 occupies less than the predefined ratio/percentage, the Tx UE 402 does not select CAPC for the TB and instead evaluates the next highest priority SL CAPC (i.e., CAPC 3, associated with the second MAC SDU 504). Here, the aggregated data having SL CAPC index/value of ‘3’ or lower (i.e., having priority level greater than or equal to CAPC 3) occupies 20%+65%-85% of the TB. Because 85% exceeds the 75% threshold, the Tx UE 402 selects SL CAPC 3 for the TB.

According to embodiments of the fourth solution, the UE is preconfigured with a first set of one or more SL CAPC priorities and an associated first SL CAPC priority. If the TB contains only data from SL logical channel(s) with MAC SDU corresponding to any SL CAPC priorities in the first set, then the UE uses the associated first SL CAPC priority for the TB.

For example, assume that the first set contains a first CAPC priority and a second CAPC priority. According to the fourth solution, if the data with a TB consists only of data from SL logical channels corresponding to the first or second CAPC priority, then the UE uses the first associated CAPC priority for the TB.

According to embodiments of a fifth solution, the UE uses as a CAPC priority for a TB the SL CAPC priority of the SL logical channel(s) with MAC SDU multiplexed in the TB that occupies the highest ratio of the total TB size.

For example, if data corresponding to a first SL CAPC priority occupies 20% of the TB, and data corresponding to a second SL CAPC priority occupies 65% of the TB, and data corresponding to a third SL CAPC priority occupies 15% of the TB, then the UE uses the second SL CAPC priority as priority for the TB. For cases where the amount of data/ratio is the same for more than one SL CAPC priority, it may be left to UE implementation which SL CAPC priority to select for the TB.

According to embodiments of the sixth solution, a UE is allowed to not multiplex MAC SDU(s) of a SL logical channel, e.g., the STCH, having a lower CAPC into a MAC PDU when the MAC PDU contains MAC SDU(s) of a SL logical channel having the highest CAPC, e.g. STCH or SCCH or SBCCH, and/or MAC CE(s)-even if there is data for such a SL logical channel available for transmission in the UEs buffer. According to this solution, in order to avoid the UE having to select/use a low CAPC for the transmission of a SL MAC PDU carrying high priority data such as SCCH/SBCCH MAC SDU(s) or MAC CE(s) since also data of a SL logical channel having a low CAPC is multiplexed within this MAC PDU, the UE is allowed to multiplex a padding PDU into the MAC PDU rather than data of a SL LCH having a low CAPC.

According to one specific implementation of the sixth solution, a UE is only allowed to multiplex padding into a MAC PDU when the amount of data having the highest CAPC within the MAC PDU exceeds a certain configured size threshold such as a value or a percentage. Such a size threshold may be configured by higher layer signaling.

According to another implementation of the sixth solution, the UE shall not multiplex MAC SDU(s) of SL LCHs having a lower CAPC than a configured CAPC threshold in case the MAC PDU contains data of a SL LCH having the highest CAPC (i.e., lowest signaled value=1), e.g., SL MAC CEs or STCH/SCCH/SBCCH. The UE is configured with this CAPC threshold, e.g., by means of RRC signaling.

During the Logical Channel Prioritization (LCP) procedure or resource allocation procedure (mode 2), i.e., when the SL MAC PDU is generated, the UE checks whether a SL LCH is allowed to multiplex data within the MAC PDU depending on the CAPC configured/specified for a SL LCH. For cases when data of a LCH having the highest CAPC or SL MAC CEs are multiplexed in a MAC PDU, the UE shall not multiplex data of other SL LCHs having a CAPC priority lower than the configured CAPC priority threshold in the MAC PDU.

According to embodiments of a seventh solution, the UE uses the highest CAPC priority for a SL TB, if there is data contained in the TB which has the highest priority CAPC, i.e., highest priority CAPC=1. According to one implementation of the seventh solution, such data could be either a SL MAC CE or a SCCH MAC SDU or SBCCH MAC SDU or STCH MAC SDU. According to the seventh solution, to ensure that for cases that a SL TB is comprised of data with the highest priority CAPC, the UE uses the highest priority CAPC for the transmission of the SL TB regardless of what other data is multiplexed in the SL TB.

According to embodiments of an eighth solution, the UE may remove or exclude one or more MAC SDUs from a SL TB for cases that the CAPC determined for the SL TB cannot meet the PDB requirements of the TB. For example, the LBT procedure—including the contention window determined as a function of the CAPC—may not reach the condition for allowing a transmission before the PDB expires. This may be known at the initialization step of the channel access procedure if the minimum total required channel access sensing duration extends beyond the PDB of the TB.

Therefore, in order to be able to meet the PDB requirements, the UE may remove data from a SL LCH having the lowest priority CAPC such that the CAPC priority associated with the SL TB is increased. For example, the UE may add padding in order to fill the TB size after removing the low CAPC priority data.

According to an alternative implementation of the eight solution, the UE does not include the highest priority CAPC data in the TB and instead triggers a Scheduling Request (SR) on the Uu in order to request SL resource from the gNB for the high priority CAPC data. In such embodiments, the gNB may signal a CAPC value within the SL DCI which the UE needs to apply for the corresponding SL transmission.

According to embodiments of a ninth solution, there can be a weighted average calculation for deriving the final CAPC based on a weight coefficient for each data type, e.g., very high weights for certain MAC CEs/SCCH SDUs and/or SBCCH SDU(s), etc., and lower weights for other MAC CEs/SCCH SDUs and/or SBCCH SDU(s) and data LCHs.

Assuming there are Na data types multiplexed into a TB, the calculation may be done according to the following equation:

$$\frac{{\sum }_{t = 1}^{{N}_{d}} {w}_{t} \times {p}_{t}}{{\sum }_{t = 1}^{{N}_{d}} {w}_{t}} \qquad Eq . l$$

where wₜ is the weight coefficient for data type t and pt is the CAPC priority associated with data type t. The result of this formula may be rounded (e.g., up or down) to arrive at an integer CAPC priority level.

According to an implementation of the ninth solution, the weight coefficients wₜ may be configured as parameter for each data type, e.g., very high weights for certain MAC CEs/SCCH SDUs and/or SBCCH SDU(s), etc., and lower weights for other MAC CEs/SCCH SDUs and/or SBCCH SDU(s) and data LCHs. This configuration may be part of the resource pool configuration.

According to embodiments of a tenth solution, there can be a weighted average calculation for deriving the final CAPC. Assuming four CAPC priority levels, the calculation may be done according to the following equation:

$$\frac{{\sum }_{p = 1}^{4} {w}_{p} \times p}{{\sum }_{p = 1}^{4} {w}_{p}} \qquad Eq . 2$$

where wₚ is the weight coefficient for CAPC priority level p. The result of this formula may be rounded (e.g., up or down) to arrive at an integer CAPC priority level. According to an implementation of the tenth solution, the weight coefficients wₚ may be configured as parameters for each CAPC priority class. This configuration may be part of the resource pool configuration.

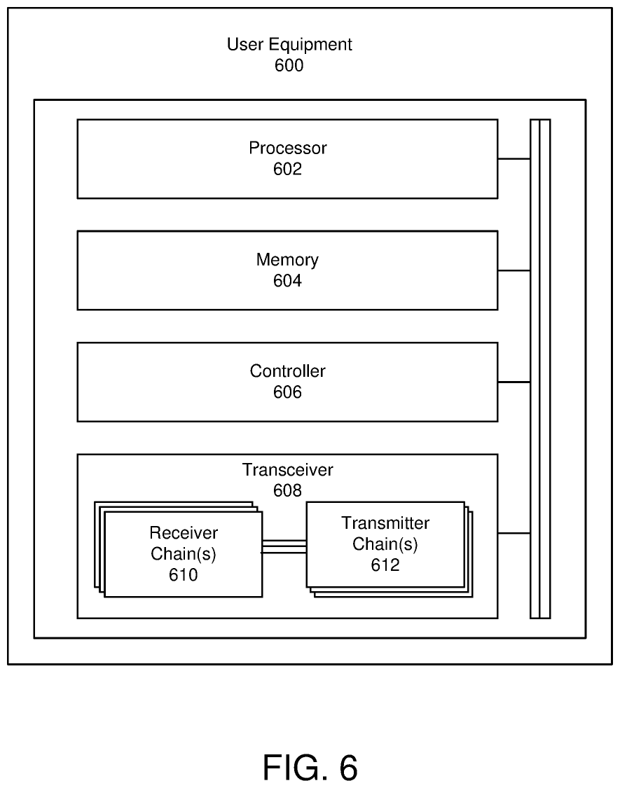

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, a Field Programable Gate Array (FPGA), or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the UE functions described herein (e.g., executing, by the processor 602, instructions stored in the memory 604). For example, the processor 602 may support wireless communication at the UE 600 in accordance with examples as disclosed herein. The UE 600 may be configured to support a means for generating an SL TB to be transmitted to a set of Rx UEs over a SL channel, wherein the SL TB comprises data units associated with a plurality of SL LCHs, each SL LCH associated with a respective CAPC.

In certain implementations, the respective CAPC is based at least in part on a delay requirement (e.g., PDB) of a corresponding SL LCH. In some implementations, the plurality of SL LCHs comprises at least one STCH. In certain implementations, the data units comprise MAC SDUs.

The UE 600 may be configured to support a means for determining a highest priority CAPC associated with the SL TB. The UE 600 may be configured to support a means for selecting a CAPC value for the SL TB based at least in part on the highest priority CAPC satisfying a threshold.

In some implementations, to select the CAPC value, the UE 600 may be configured to select the highest priority CAPC in response to the highest priority CAPC satisfying the threshold. In certain implementations, to select the CAPC value, the UE 600 may be configured to select a lowest priority CAPC in response to the highest priority CAPC not satisfying the threshold, where the lowest priority CAPC is associated with a longer contention window (CW) than the highest priority CAPC.

In certain implementations, to select the CAPC value, the UE is further configured to select the CAPC value based at least in part on an amount of data associated with the highest priority CAPC satisfying a predetermined amount. In certain implementations, to select the CAPC value, the UE is further configured to select the CAPC value based at least in part on a ratio of data associated with the highest priority CAPC satisfying a predetermined ratio.

The UE 600 may be configured to support a means for performing an LBT procedure using a set of LBT parameters corresponding to the selected CAPC value. In some implementations, the UE 600 may be further configured to remove one or more data units from the SL TB in response to the selected CAPC not satisfying a packet delay budget associated with one of the plurality of SL LCHs.

The UE 600 may be configured to support a means for transmitting the SL TB over an SL channel based at least in part on a success of the LBT procedure. In some implementations, the UE 600 may be configured to initiate a SL communication with the set of Rx UEs over an unlicensed band (i.e., in shared spectrum), where the SL communication corresponds to the one or more SL LCHs.

In certain implementations, to initiate the SL communication, the UE 600 may be configured to select a SL grant, wherein the SL grant fails to indicate a CAPC value for a corresponding SL transmission. In certain implementations, the UE 600 may be further configured to: A) perform a sensing procedure associated with the unlicensed band; and B) determine an available SL resource for the SL communication based at least in part on a result of the sensing procedure.

The controller 606 may manage input and output signals for the UE 600. The controller 606 may also manage peripherals not integrated into the UE 600. In some implementations, the controller 606 may utilize an operating system (OS) such as iOS®, ANDROID®, WINDOWS®, or other operating systems (OSes). In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., a low-noise amplifier (LNA)) configured to amplify the received signal. The receiver chain 610 may include at least one demodulator configured to demodulate the receiving signal and obtain the transmitted data by reversing the modulation technique applied during transmission of the signal. The receiver chain 610 may include at least one decoder for decoding and processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

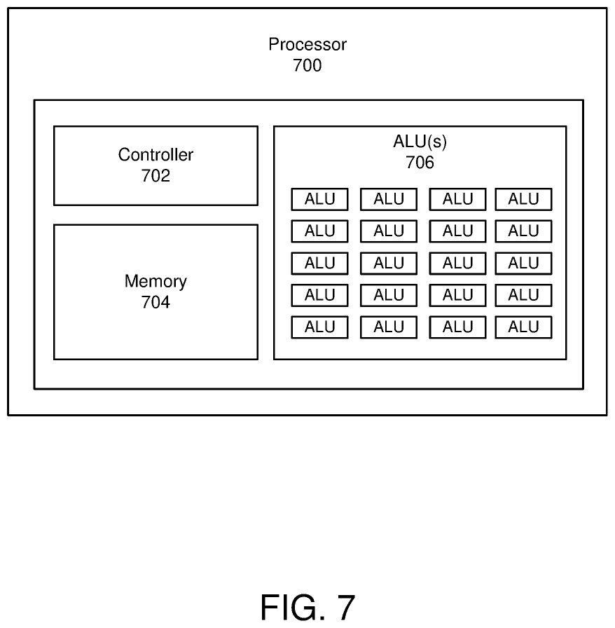

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. For example, the processor 700 may perform one or more of the UE functions described herein. The processor 700 may be configured to or operable to support a means for generating an SL TB to be transmitted to a set of Rx UEs over a SL channel, wherein the SL TB comprises data units associated with a plurality of SL LCHs, each SL LCH associated with a respective CAPC.

In certain implementations, the respective CAPC is based at least in part on a delay requirement (e.g., PDB) of a corresponding SL LCH. In some implementations, the plurality of SL LCHs comprises at least one STCH. In certain implementations, the data units comprise MAC SDUs.

The processor 700 may be configured to support a means for determining a highest priority CAPC associated with the SL TB. The processor 700 may be configured to support a means for selecting a CAPC value for the SL TB based at least in part on the highest priority CAPC satisfying a threshold.

In some implementations, to select the CAPC value, the processor 700 may be configured to select the highest priority CAPC in response to the highest priority CAPC satisfying the threshold. In certain implementations, to select the CAPC value, the processor 700 may be configured to select a lowest priority CAPC in response to the highest priority CAPC not satisfying the threshold, where the lowest priority CAPC is associated with a longer contention window (CW) than the highest priority CAPC.

In certain implementations, to select the CAPC value, the UE is further configured to select the CAPC value based at least in part on an amount of data associated with the highest priority CAPC satisfying a predetermined amount. In certain implementations, to select the CAPC value, the UE is further configured to select the CAPC value based at least in part on a ratio of data associated with the highest priority CAPC satisfying a predetermined ratio.

The processor 700 may be configured to support a means for performing an LBT procedure using a set of LBT parameters corresponding to the selected CAPC value. In some implementations, the processor 700 may be further configured to remove one or more data units from the SL TB in response to the selected CAPC not satisfying a packet delay budget associated with one of the plurality of SL LCHs.

The processor 700 may be configured to support a means for transmitting the SL TB over an SL channel based at least in part on a success of the LBT procedure. In some implementations, the processor 700 may be configured to initiate a SL communication with the set of Rx UEs over an unlicensed band (i.e., in shared spectrum), where the SL communication corresponds to the one or more SL LCHs.

In certain implementations, to initiate the SL communication, the processor 700 may be configured to select a SL grant, wherein the SL grant fails to indicate a CAPC value for a corresponding SL transmission. In certain implementations, the processor 700 may be further configured to: A) perform a sensing procedure associated with the unlicensed band; and B) determine an available SL resource for the SL communication based at least in part on a result of the sensing procedure.

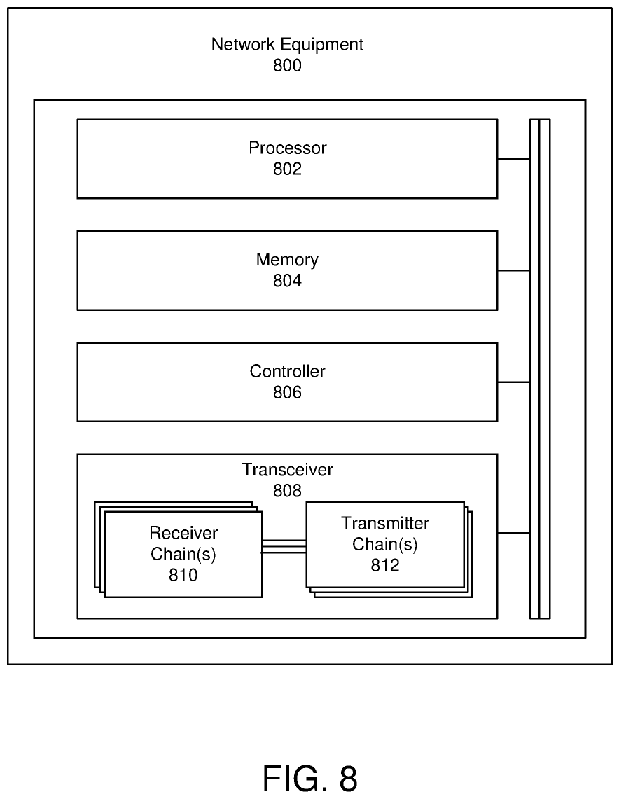

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for configuring one or more UEs with a CAPC threshold for SL operation.

In some implementations, the NE 800 may be configured to support means for configuring a UE with resource pool configuration parameters that indicate an amount and/or ratio of data for CAPC selection during SL operation. In some implementations, the NE 800 may be configured to support means for configuring a UE with a first set of (one or more) SL CAPC priorities and an associated first SL CAPC priority.

In some implementations, the NE 800 may be configured to support means for configuring a UE with a MAC PDU size threshold for CAPC selection during SL operation. In some implementations, the NE 800 may be configured to support means for configuring a UE with a weight coefficient for one or more data types for CAPC selection during SL operation.

The controller 806 may manage input and output signals for the NE 800. The controller 806 may also manage peripherals not integrated into the NE 800. In some implementations, the controller 806 may utilize an OS such as iOS®, ANDROID®, WINDOWS®, or other OSes. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the receiving signal and obtain the transmitted data by reversing the modulation technique applied during transmission of the signal. The receiver chain 810 may include at least one decoder for decoding and processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

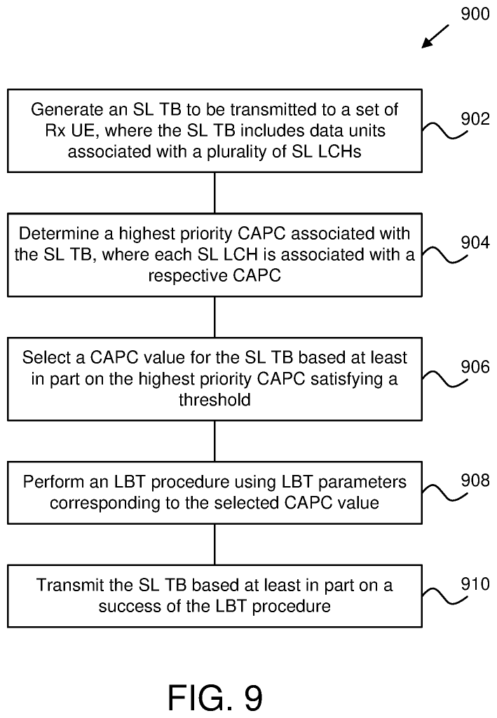

FIG. 9 illustrates a flowchart of a method 900 in accordance with aspects of the present disclosure. The operations of the method 900 may be implemented by a UE as described herein. In some implementations, the UE may execute a set of instructions to control the function elements of the UE to perform the described functions.

At Step 902, the method 900 may include generating an SL TB to be transmitted to a set of Rx UEs. Here, the SL TB includes data units associated with a plurality of SL LCHs. The operations of Step 902 may be performed in accordance with examples as described herein. In some implementations, aspects of the operations of Step 902 may be performed by a UE as described with reference to FIG. 6.

At Step 904, the method 900 may include determining a highest priority CAPC associated with the SL TB, where each SL LCH is associated with a respective CAPC. The operations of Step 904 may be performed in accordance with examples as described herein. In some implementations, aspects of the operations of Step 904 may be performed by a UE as described with reference to FIG. 6.

At Step 906, the method 900 may include selecting a CAPC value for the SL TB based at least in part on the highest priority CAPC satisfying a threshold. The operations of Step 906 may be performed in accordance with examples as described herein. In some implementations, aspects of the operations of Step 906 may be performed a UE as described with reference to FIG. 6.

At Step 908, the method 900 may include performing an LBT procedure using a set of LBT parameters corresponding to the selected CAPC value. The operations of Step 908 may be performed in accordance with examples as described herein. In some implementations, aspects of the operations of Step 908 may be performed a UE as described with reference to FIG. 6.

At Step 910, the method 900 may include transmitting the SL TB based at least in part on a success of the LBT procedure. The operations of Step 910 may be performed in accordance with examples as described herein. In some implementations, aspects of the operations of Step 910 may be performed a UE as described with reference to FIG. 6.

It should be noted that the method 900 described herein describes one possible implementation, and that the operations and the steps may be rearranged or otherwise modified and that other implementations are possible.

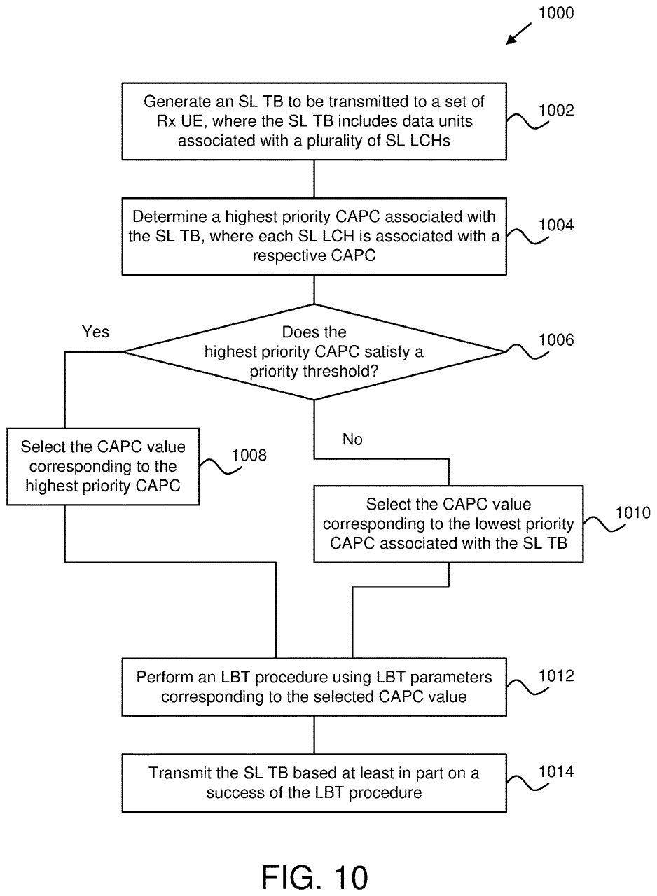

FIG. 10 illustrates a flowchart of a method 1000 in accordance with aspects of the present disclosure. The operations of the method 1000 may be implemented by a UE as described herein. In some implementations, the UE may execute a set of instructions to control the function elements of the UE to perform the described functions.

At Step 1002, the method 1000 may include generating an SL TB to be transmitted to a set of Rx UEs, where the SL TB includes data units associated with a plurality of SL LCHs. The operations of Step 1002 may be performed in accordance with examples as described herein. In some implementations, aspects of the operations of Step 1002 may be performed by a UE as described with reference to FIG. 6.

At Step 1004, the method 1000 may include determining a highest priority CAPC associated with the SL TB, where each SL LCH is associated with a respective CAPC. The operations of Step 1004 may be performed in accordance with examples as described herein. In some implementations, aspects of the operations of Step 1004 may be performed by a UE as described with reference to FIG. 6.

At Step 1006, the method 1000 may include determining whether the highest priority CAPC satisfies a priority threshold. The operations of Step 1006 may be performed in accordance with examples as described herein. In some implementations, aspects of the operations of Step 1006 may be performed a UE as described with reference to FIG. 6.

At Step 1008, the method 1000 may include selecting the CAPC value corresponding to the highest priority CAPC when the highest CAPC satisfies the priority threshold. The operations of Step 1008 may be performed in accordance with examples as described herein. In some implementations, aspects of the operations of Step 1008 may be performed a UE as described with reference to FIG. 6.

At Step 1010, the method 1000 may include selecting the CAPC value corresponding to the lowest priority CAPC when the highest CAPC does not satisfy the priority threshold. The operations of Step 1010 may be performed in accordance with examples as described herein. In some implementations, aspects of the operations of Step 1010 may be performed a UE as described with reference to FIG. 6.

At Step 1012, the method 1000 may include performing an LBT procedure using a set of LBT parameters corresponding to the selected CAPC value. The operations of Step 1012 may be performed in accordance with examples as described herein. In some implementations, aspects of the operations of Step 1012 may be performed a UE as described with reference to FIG. 6.

At Step 1014, the method 1000 may include transmitting the SL TB based at least in part on a success of the LBT procedure. The operations of Step 1014 may be performed in accordance with examples as described herein. In some implementations, aspects of the operations of Step 1014 may be performed a UE as described with reference to FIG. 6.

It should be noted that the method 1000 described herein describes one possible implementation, and that the operations and the steps may be rearranged or otherwise modified and that other implementations are possible.

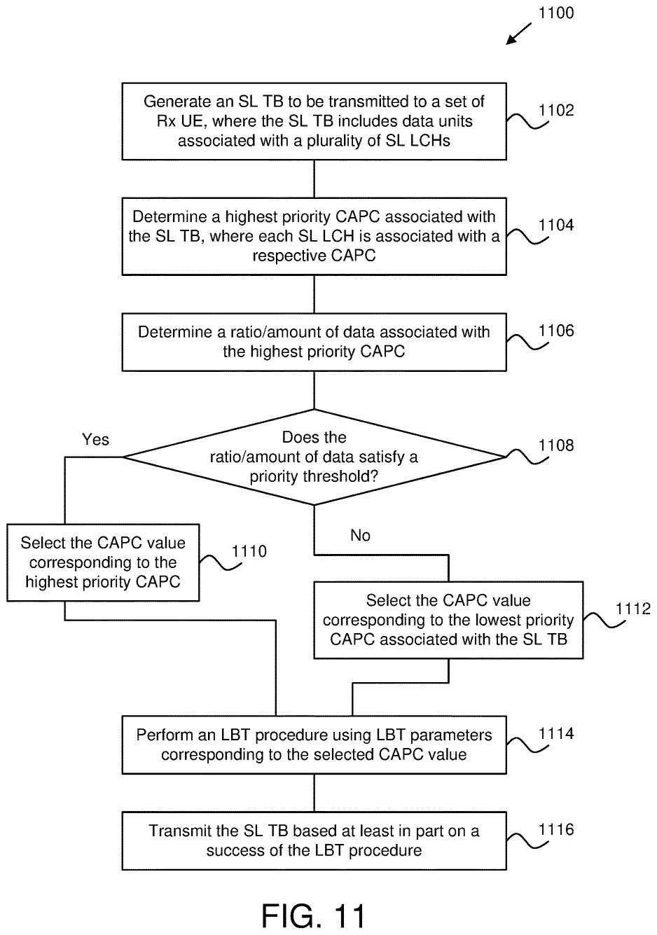

FIG. 11 illustrates a flowchart of a method 1100 in accordance with aspects of the present disclosure. The operations of the method 1100 may be implemented by a UE as described herein. In some implementations, the UE may execute a set of instructions to control the function elements of the UE to perform the described functions.

At Step 1102, the method 1100 may include generating an SL TB to be transmitted to a set of Rx UEs, where the SL TB includes data units associated with a plurality of SL LCHs. The operations of Step 1102 may be performed in accordance with examples as described herein. In some implementations, aspects of the operations of Step 1102 may be performed by a UE as described with reference to FIG. 6.

At Step 1104, the method 1100 may include determining a highest priority CAPC associated with the SL TB, where each SL LCH is associated with a respective CAPC. The operations of Step 1104 may be performed in accordance with examples as described herein. In some implementations, aspects of the operations of Step 1104 may be performed by a UE as described with reference to FIG. 6.

At Step 1106, the method 1100 may include determining whether a ratio or amount of data in the SL TB associated with the highest priority CAPC satisfies a priority threshold. The operations of Step 1106 may be performed in accordance with examples as described herein. In some implementations, aspects of the operations of Step 1106 may be performed a UE as described with reference to FIG. 6.

At Step 1108, the method 1100 may include determining whether the ratio or amount of data associated with the highest priority CAPC satisfies a priority threshold. The operations of Step 1108 may be performed in accordance with examples as described herein. In some implementations, aspects of the operations of Step 1108 may be performed a UE as described with reference to FIG. 6.

At Step 1110, the method 1100 may include selecting the CAPC value corresponding to the highest priority CAPC when the ratio or amount of data satisfies the priority threshold. The operations of Step 1110 may be performed in accordance with examples as described herein. In some implementations, aspects of the operations of Step 1110 may be performed a UE as described with reference to FIG. 6.

At Step 1112, the method 1100 may include selecting the CAPC value corresponding to the lowest priority CAPC when the ratio or amount of data does not satisfy the priority threshold. The operations of Step 1112 may be performed in accordance with examples as described herein. In some implementations, aspects of the operations of Step 1112 may be performed a UE as described with reference to FIG. 6.

At Step 1114, the method 1100 may include performing an LBT procedure using a set of LBT parameters corresponding to the selected CAPC value. The operations of Step 1114 may be performed in accordance with examples as described herein. In some implementations, aspects of the operations of Step 1114 may be performed a UE as described with reference to FIG. 6.

At Step 1116, the method 1100 may include transmitting the SL TB based at least in part on a success of the LBT procedure. The operations of Step 1116 may be performed in accordance with examples as described herein. In some implementations, aspects of the operations of Step 1116 may be performed a UE as described with reference to FIG. 6.

It should be noted that the method 1100 described herein describes one possible implementation, and that the operations and the steps may be rearranged or otherwise modified and that other implementations are possible.

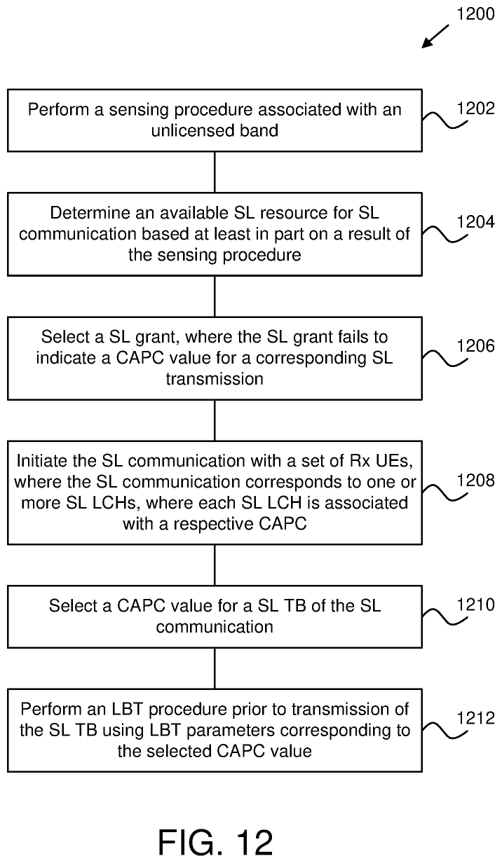

FIG. 12 illustrates a flowchart of a method 1200 in accordance with aspects of the present disclosure. The operations of the method 1200 may be implemented by a UE as described herein. In some implementations, the UE may execute a set of instructions to control the function elements of the UE to perform the described functions.

At Step 1202, the method 1200 may include performing a sensing procedure associated with an unlicensed band (i.e., a radio band in shared spectrum). The operations of Step 1202 may be performed in accordance with examples as described herein. In some implementations, aspects of the operations of Step 1202 may be performed by a UE as described with reference to FIG. 6.

At Step 1204, the method 1200 may include determining an available SL resource for SL communication based at least in part on a result of the sensing procedure. The operations of Step 1204 may be performed in accordance with examples as described herein. In some implementations, aspects of the operations of Step 1204 may be performed by a UE as described with reference to FIG. 6.

At Step 1206, the method 1200 may include selecting an SL grant, where the SL grant fails to indicate a CAPC value for a corresponding SL transmission. The operations of Step 1206 may be performed in accordance with examples as described herein. In some implementations, aspects of the operations of Step 1206 may be performed a UE as described with reference to FIG. 6.

At Step 1208, the method 1200 may include initiating the SL communication with a set of Rx UEs, where the SL communication corresponds to one or more SL LCHs, where each SL LCH is associated with a respective CAPC. The operations of Step 1208 may be performed in accordance with examples as described herein. In some implementations, aspects of the operations of Step 1208 may be performed a UE as described with reference to FIG. 6.

At Step 1210, the method 1200 may include selecting a CAPC value for the SL TB, i.e., in accordance with one or more of the aspects described above. The operations of Step 1210 may be performed in accordance with examples as described herein. In some implementations, aspects of the operations of Step 1210 may be performed a UE as described with reference to FIG. 6.

At Step 1212, the method 1200 may include performing an LBT procedure using a set of LBT parameters corresponding to the selected CAPC value. The operations of Step 1212 may be performed in accordance with examples as described herein. In some implementations, aspects of the operations of Step 1212 may be performed a UE as described with reference to FIG. 6.

It should be noted that the method 1200 described herein describes one possible implementation, and that the operations and the steps may be rearranged or otherwise modified and that other implementations are possible.

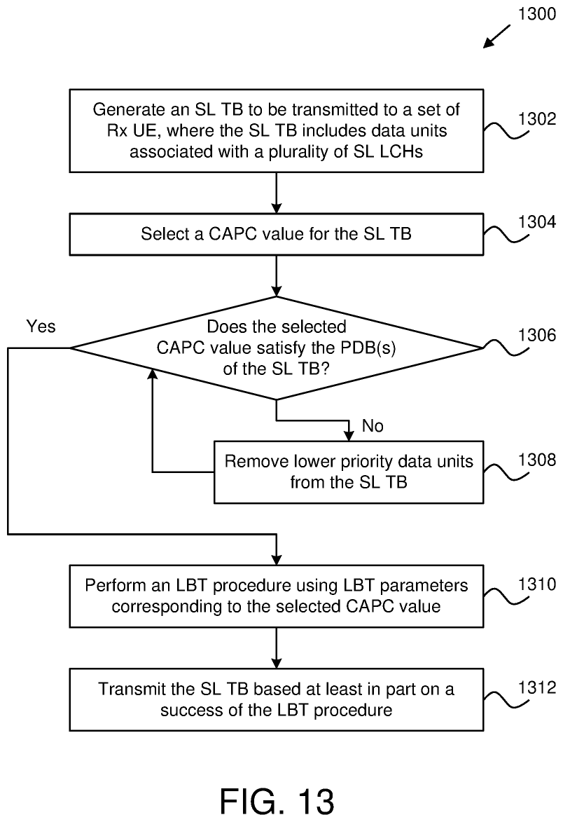

FIG. 13 illustrates a flowchart of a method 1300 in accordance with aspects of the present disclosure. The operations of the method 1300 may be implemented by a UE as described herein. In some implementations, the UE may execute a set of instructions to control the function elements of the UE to perform the described functions.

At Step 1302, the method 1300 may include generating an SL TB to be transmitted to a set of Rx UEs, where the SL TB includes data units associated with a plurality of SL LCHs. The operations of Step 1302 may be performed in accordance with examples as described herein. In some implementations, aspects of the operations of Step 1302 may be performed by a UE as described with reference to FIG. 6.

At Step 1304, the method 1300 may include selecting a CAPC value for the SL TB, i.e., in accordance with one or more of the aspects described above. The operations of Step 1304 may be performed in accordance with examples as described herein. In some implementations, aspects of the operations of Step 1304 may be performed by a UE as described with reference to FIG. 6.

At Step 1306, the method 1300 may include determining whether the selected CAPC value satisfies the one or more PDBs associated with the SL TB. The operations of Step 1306 may be performed in accordance with examples as described herein. In some implementations, aspects of the operations of Step 1306 may be performed a UE as described with reference to FIG. 6.

At Step 1308, the method 1300 may include removing one or more lower priority data units from the SL TB when the selected CAPC value does not satisfy the PDB(s) associated with the SL TB. The operations of Step 1308 may be performed in accordance with examples as described herein. In some implementations, aspects of the operations of Step 1308 may be performed a UE as described with reference to FIG. 6.

At Step 1310, the method 1000 may include performing an LBT procedure using a set of LBT parameters corresponding to the selected CAPC value. The operations of Step 1310 may be performed in accordance with examples as described herein. In some implementations, aspects of the operations of Step 1310 may be performed a UE as described with reference to FIG. 6.

At Step 1312, the method 1000 may include transmitting the SL TB based at least in part on a success of the LBT procedure. The operations of Step 1312 may be performed in accordance with examples as described herein. In some implementations, aspects of the operations of Step 1312 may be performed a UE as described with reference to FIG. 6.

It should be noted that the method 1300 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
generate an Sidelink (SL) transport block (TB) to be transmitted to a set of receiving UEs (Rx UEs), wherein the SL TB comprises data units associated with a plurality of SL logical channels (LCHs), each SL LCH associated with a respective channel access priority class (CAPC);
determine a highest priority CAPC associated with the SL TB;
select a CAPC value for the SL TB based at least in part on the highest priority CAPC satisfying a threshold;
perform a listen-before-talk (LBT) procedure using a set of LBT parameters corresponding to the selected CAPC value; and
transmit the SL TB based at least in part on a success of the LBT procedure.

2. The UE of claim 1, wherein to select the CAPC value, the at least one processor is configured to cause the UE to select the highest priority CAPC in response to the highest priority CAPC satisfying the threshold.

3. The UE of claim 2, wherein to select the CAPC value, the at least one processor is configured to cause the UE to select a lowest priority CAPC in response to the highest priority CAPC not satisfying the threshold, wherein the lowest priority CAPC is associated with a longer contention window (CW) than the highest priority CAPC.

4. The UE of claim 1, wherein to select the CAPC value, the at least one processor is configured to cause the UE to further select the CAPC value based at least in part on an amount or a ratio of data associated with the highest priority CAPC satisfying a predetermined amount or a predetermined ratio.

5. The UE of claim 1, wherein the at least one processor is further configured to cause the UE to initiate a SL communication with the set of Rx UEs over an unlicensed band, and wherein the SL communication corresponds to the one or more SL LCHs.

6. The UE of claim 5, wherein to initiate the SL communication, the at least one processor is configured to cause the UE to select a SL grant, wherein the SL grant fails to indicate a CAPC value for a corresponding SL transmission.

7. The UE of claim 5, wherein to initiate the SL communication, the at least one processor is configured to cause the UE to:
perform a sensing procedure associated with the unlicensed band; and
determine an available SL resource for the SL communication based at least in part on a result of the sensing procedure.

8. The UE of claim 1, wherein the plurality of SL LCHs comprises at least one SL traffic channel (STCH).

9. The UE of claim 1, wherein the respective CAPC is based at least in part on a delay requirement of a corresponding SL LCH.

10. The UE of claim 1, wherein the at least one processor is further configured to cause the UE to remove one or more data units from the SL TB in response to the selected CAPC not satisfying a packet delay budget associated with one of the plurality of SL LCHs, wherein the data units comprise medium access control (MAC) service data units (SDUs).

11. A method performed by a user equipment (UE), the method comprising:
generating an Sidelink (SL) transport block (TB) to be transmitted to a set of receiving UEs (Rx UEs), wherein the SL TB comprises data units associated with a plurality of SL logical channels (LCHs), each SL LCH associated with a respective channel access priority class (CAPC);
determining a highest priority CAPC associated with the SL TB;
selecting a CAPC value for the SL TB based at least in part on the highest priority CAPC satisfying a threshold;
performing a listen-before-talk (LBT) procedure using a set of LBT parameters corresponding to the selected CAPC value; and
transmitting the SL TB based at least in part on a success of the LBT procedure.

12. The method processer of claim 11, wherein selecting the CAPC value comprises selecting the highest priority CAPC in response to the highest priority CAPC satisfying the threshold.

13. The method of claim 12, wherein selecting to select the CAPC value comprises selecting a lowest priority CAPC in response to the highest priority CAPC not satisfying the threshold, wherein the lowest priority CAPC is associated with a longer contention window (CW) than the highest priority CAPC.

14. The method processor of claim 11, wherein selecting the CAPC value further comprises selecting the CAPC value based at least in part on an amount or a ratio of data associated with the highest priority CAPC satisfying a predetermined amount or a predetermined ratio.

15. The method processer of claim 11, further comprising initiating a SL communication with the set of Rx UEs over an unlicensed band, and wherein the SL communication corresponds to the one or more SL LCHs.

16. The method of claim 15, wherein initiating the SL communication comprises selecting a SL grant, wherein the SL grant fails to indicate a CAPC value for a corresponding SL transmission.

17. The method of claim 15, wherein initiating the SL communication comprises:
performing a sensing procedure associated with the unlicensed band; and
determining an available SL resource for the SL communication based at least in part on a result of the sensing procedure.

18. The method of claim 11, wherein the plurality of SL LCHs comprises at least one SL traffic channel (STCH).

19. The method of claim 11, wherein the respective CAPC is based at least in part on a delay requirement of a corresponding SL LCH.

20. The method of claim 11, further comprising removing one or more data units from the SL TB in response to the selected CAPC not satisfying a packet delay budget associated with one of the plurality of SL LCHs, wherein the data units comprise medium access control (MAC) service data units (SDUs).
